(19) United States
(12) Patent Application Publication
(10) Pub. No.: US 2014/0012974 A1
(43) Pub. Date: Jan. 9, 2014

(54) ON-LINE SYSTEM FOR MONITORING USER ACTIVITIES ON AN IT DEVICE

(71) Applicants: Ales Studeny, Zdar nad Sazavou (CZ); Radek Grodl, Zdar nad Sazavou (CZ); Roman Jezdik, Brno Utechov (CZ)

(72) Inventors: Ales Studeny, Zdar nad Sazavou (CZ); Radek Grodl, Zdar nad Sazavou (CZ); Roman Jezdik, Brno Utechov (CZ)

(73) Assignee: ALC, Spol. S.R.O., Zdar nad Sazavou (CZ)

(21) Appl. No.: 13/544,087

(22) Filed: Jul. 9, 2012

(51) Int. Cl. G06F 15/173

(52) U.S. Cl. 709/224

(57) ABSTRACT

On-line system for monitoring user activity on an IT device, the system including a control application (APP) and a monitoring application (AG), where the control application (APP) is situated on a central server (SRV) on the Internet, and the monitoring application (AG) is installed on the monitored IT device (IT). The monitoring application (AG) can be interconnected with the control device (APP) by the Internet. The monitoring application (AG) stores the collected data in a local data store (AG-DB), and subsequently the stored data is transmitted via the Internet to the control application (APP). The collected data is processed by the control application (APP) and subsequently the collected data is stored in the database (DB).

### FIELD OF THE INVENTION

The present invention is directed to an on-line system for monitoring user activities on an IT device.

### BACKGROUND OF THE INVENTION

IT devices have quickly become a main tool for people's work. Unfortunately, IT devices don't just simplify work, but also provide workers with opportunity for nonproductive activity, or even activity potentially damaging to an employing company. The same problem can appear in a household, where computers once became a necessary aid for pupils or students. Also, here, the computers enable the user with a possibility to do unwanted activities, or even illegal activities.

The owners of the IT devices (or the employers providing the IT devices) started to care, in which manner their devices are used or misused. Many technological solutions were created, solutions enabling the monitoring of activity on computers in the customer's local network. Collected information is sent to a control computer or a server, situated in the local network, where data about user's activity on the monitored devices is stored.

By the incoming of the Internet the situation became more acute, and the risk increased. Again, many new technological solutions appeared, each capable of monitoring and/or blocking activities on the Internet. These solutions monitor activities at the entry point (interface) to the Internet, at the Firewall. However, these technologies just monitor activities on the Internet, not local activities on the IT device.

In the present time, the common technological solutions require a server or another technological item, which is arranged in the client's local network. It is a manager's or parent's computer or a computer in a server room, where collected data about activities made on the IT device are stored. As well, it can be another specialized hardware intended for monitoring of activities at the network. The operating of such tool usually requires IT experiences or there are subsequent costs for IT crew. Furthermore, those technologies don't allow easy monitoring of user activity on computers placed in a plurality of offices or branch offices.

In WO 02/03219, the method and the system for monitoring user activity in one or more computer networks is presented, which separates information from data, which can identify the particular person, on a monitored computer and store them in a database in such manner, that user's privacy is protected. In another embodiment the system creates anonymous identifier and connects the set the identifier with collected data from the network. The collected data comprise just informations about user behavior in the network, but not activity done by the computer. In addition, the system requires implementation of interlinks.

In U.S. Pat. No. 7,020,082, the network monitoring device and an associated method is presented, each comprising a monitoring module placed in an entry point to the network, through which transmission data are passing, and a monitoring database intended for communication with the monitoring module. Also in this example, the collected data comprises only information about user activity on the Internet. In addition, the system requires hardware situated inside a local network.

In U.S. Pat. No. 6,795,856, a system and method for monitoring entry of a computer to the Internet is presented. It comprises a client module intended for monitoring each entry to the Internet, whereas each entry is archived in the computer, and information about each entry is sent to a remote web server. The client module carries out all activity of the system. Also, in this example, the transmitted data includes only information about user activity done on the Internet.

One aspect of the present invention is an on-line system and method enabling the monitoring of user activities on an IT device, including activities that have no relation to the Internet or to a respective network communication, where the on-line system and method is easy to install, control and access by authorized persons.

### SUMMARY OF THE INVENTION

The above mentioned disadvantages are considerably eliminated by on-line system for monitoring user's activities on an IT device, comprises a control application and a monitoring application, where the control application is situated on a central server on the Internet, and the monitoring application is installed on the monitored IT device, whereas the monitoring device is interconnected with the control device by the Internet.

In one advantageous embodiment of the present invention, the IT device means a computer or a smart phone or a tablet or a computer, which is a part of a machine tool or a cash desk or a TV set or a multimedial device.

The above mentioned disadvantages are considerably eliminated also by method of monitoring user's activities on a monitored IT device where the monitoring application stores the collected data in the local data store, and subsequently the stored data are sent via the Internet to the control application, which is processing the data by the control application and subsequently the collected data are stored in the database.

In another advantageous embodiment, the collected data about the monitored IT device stored in the database are subsequently via the web browser made accessable for the users of the monitored IT device, where the users can browse and/or delete their own informations and/or indicate some collected data as private and/or check the persons permitted to watch user's statistics.

In another advantageous embodiment, the data means informations about the user's activity on the monitored IT device on the Internet and/or on a local network and/or a local activity on the monitored IT device.

In a further advantageous embodiment, the collected data are analyzed by the library of models, which determines what type of activity was practiced on the monitored IT device.

### BRIEF DESCRIPTION OF THE DRAWINGS

The present invention will be better understood with reference to the following description taken in combination with the drawings. For the purpose of illustration, there are shown in the drawings certain embodiments of the present invention. In the drawings, like numerals indicate like elements throughout. It should be understood, however, that the invention is not limited to the precise arrangements, dimensions, and instruments shown. In the drawings:

FIG. 1 presents an on-line system for monitoring user activities on an IT device in accordance with one embodiment of the present invention;

FIG. 2 presents a schematic interconnection of individual parts of the on-line system for monitoring user activities on an IT device as presented in FIG. 1; and

FIG. 3 presents exemplary user statistics of activity on a monitored IT device, displayed on-line by web browser.

### DETAILED DESCRIPTION OF THE INVENTION

FIG. 1 illustrates a schematic view of an on-line system for monitoring user activity on an IT device. The system includes a control application APP situated on a central server SRV, and a monitoring application AG, alias agent, which communicates with the control application APP through the Internet, and which is installed on the monitored IT device IT. The IT device IT can be a computer, a smartphone, a tablet, or another smart device. The IT device IT can also be an apparatus including a computer, such as a machine tool, a cash desk, a television set, a multimedia device, etc. Due to the connection between the monitoring application AG and the control application APP, which is provided by a provider in the Internet, a software interface or a hardware interlink is not required in the local network. The connection S1 presents a data transmission from the IT device IT to the control application APP, which is situated on the central server SRV. The connection S2 presents a data transmission from the control application APP, which is situated on the central server SRV, to remote authorized persons OS.

The control application APP provides and ensures a collecting of data, an analysis of the data, and a creation of results in the form of statistics.

The monitoring application AG is initially placed on the central server SRV, from where the monitoring application AG can be download by registered users and installed on an IT device IT to be monitored. The monitoring application AG runs in a background and monitors and notes complete user activities. The monitoring application AG monitors all applications implemented by a user, and detects activity on it (i.e., it measures an active time). The active time is time of active data entering on an entry device of monitored IT device IT. The entry device can be a keyboard, a mouse, etc. The monitoring application AG is integrated into the web browser (e.g., Internet Explorer, Firefax, etc.) and due to this the monitoring application AG is able to determine URL addresses of web pages visited by the user. The monitoring application AG includes a local data store AG-DB situated on the monitored IT device IT, where the collected data are stored before their send-off on the central server SRV.

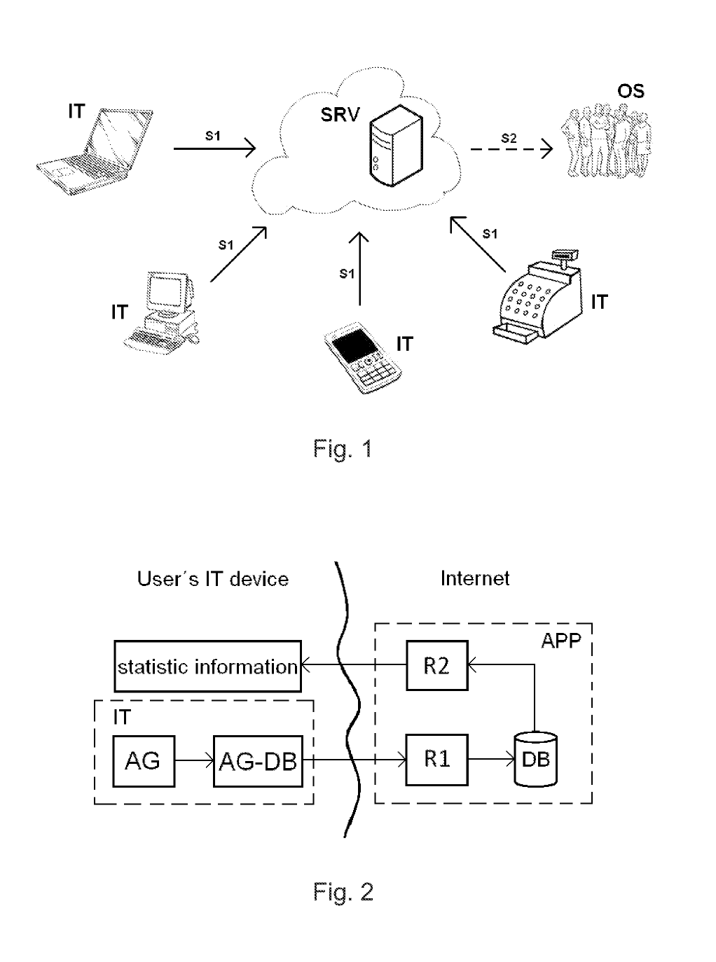

FIG. 2 Illustrates principles of monitoring activities associated with the monitored IT device IT, in accordance with the present invention. The description of various principles are explained below:

Data collected about the monitored IT device IT are stored by the monitoring application AG in the local data store AG-DB, which is situated on the monitored IT device IT. Subsequently, the stored data is transmitted (in predetermined time intervals) through the Internet on the central server SRV. Subsequently, the data are processed by the control application APP, analyzed by the library of models and furthermore stored in the database DB. The library of models contains plurality of patterns intended for identification of applications, by which the activities practiced on the monitored IT device IT can be classified. The database DB serves as a data store, which contains the library of models, detailed data collected from the monitoring applications AG, analyzed data about all activities on the monitored IT device IT and other information, such as information about customers, computers and users. In case the connection to the Internet is not available at the moment of the predetermined time interval for transmission of data, and transmission of data is not possible, the respective data is kept and stored in the local data store AG-DB until the connection to the Internet is again available. At that time all stored and not previously transmitted data will be sent.

Afterwards, users have a direct access to the data, which is stored on the central server SRV, by the web browser R2, where the users can see detailed statistics about all activities done on the monitored IT device IT. For example, a supervisor is able to see the statistics about working activities of his employees, and parents can see the activities of their children. Due to the on-line approachability, the monitoring of the IT devices IT is possible over the whole world. In order to respect a privacy protection, the stored data about an activity on the monitored IT device IT could be configured to be watched also by users of the monitored IT device IT. The user could:
turn on and turn off the monitoring of his IT device;
browse through his own statistics and the collected data about his own activities;
delete the collected data about his own activities;
check the persons permitted to watch the user's statistics; and
indicate some collected data as private

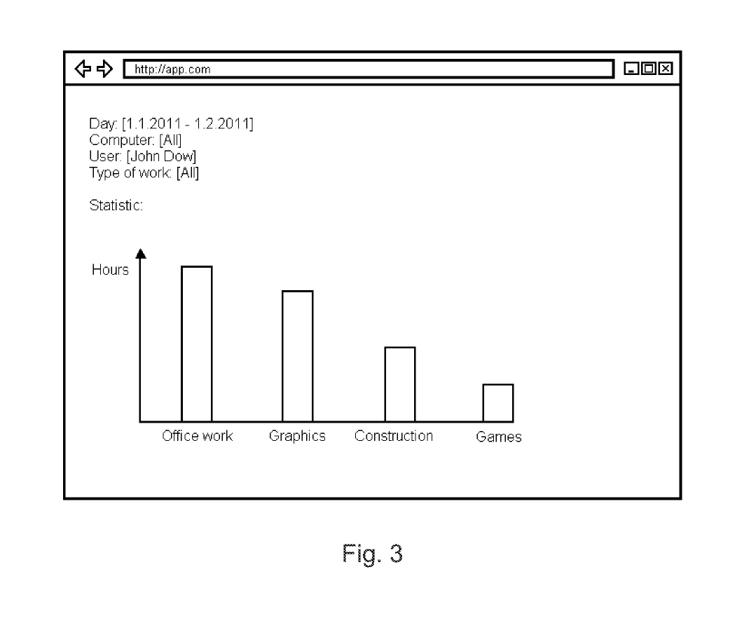

The collected data includes not just information about user activity on the Internet, but also information about user behavior on a respective local network and/or local activity on the IT device IT, such as a list of opened documents. The collected data is analyzed by the library of models, which determines what type of activity was practiced, such as engineering, programming, secretarial work, playing games, etc. That library of models is administrated by the provider of the complete on-line service. In FIG. 3, an example list of user activity on a monitored IT device IT is presented. The list is provided by web browser.

The main technological part of the system of the present invention can be hosted on-line. In view thereof, no server or no other complicated control computer, intended for storing data, which would thereby be situated on the local network, is necessary. Another advantage of the present invention provides that professional experience about IT techniques is not necessary in order to provide user activity monitoring, and the present invention system is ready to work within few minutes. Because the control application APP is situated on the main server SRV, the control application APP is reachable for a plurality of users, so this system is a so-called Multitenant system.

What is claimed is:

1. A system for monitoring user activities on an IT device, comprising:
a control application situated on a central server on the Internet, and
a monitoring application installed on the monitored IT device, wherein the monitoring application is interconnected with the control application by the Internet.

2. The system according to claim 1, wherein the IT device is a computer, a smartphone, a tablet, or a computer that is part of a machine tool, a cash desk, a television, or a multimedia device.

3. The system according to claim 1, wherein the monitoring application stores user activity data about the monitored IT device in a local data store of the monitored IT device, and subsequently the user activity data is transmitted via the Internet to the control application, the control application processes the user activity data and subsequently the processed user activity data is stored in a database.

4. The system according to claim 3, wherein the processed user activity data about the monitored IT device, stored in the database, is subsequently made accessable, via web browser, for users of the monitored IT device, where the users can browse the processed user activity data, delete certain processed user activity data, indicate certain processed user activity data as private, select persons permitted to access certain processed user activity data, and select persons permitted to access user statistics processed from the user activity data.

5. The system according to claim 3, wherein the user activity data is information about the user's activity on the monitored IT device on the Internet, on a local network, or local activity on the monitored IT device.

6. The system according to claim 3, wherein the user activity data is information about the user's local activity on the monitored IT device, and not activity associated with the Internet.

7. The system according to claim 3, wherein the user activity data is analyzed by a library of models associated with the control application, the library of models determining what type of activity was practiced on the monitored IT device.

8. A method of monitoring user activity on an IT device, the method comprising the steps of:
providing for a monitoring of user activity on an IT device by a monitoring application installed on the IT device;
providing for locally storing the monitored local user activity, as user activity data, in a local data store of the monitored IT device;
providing for a transmission of the local user activity data via the Internet to a control application situated on a central server on the Internet;
processing the user activity data, by the control application, and storing the processed user activity data, as processed data, on a database associated with the control application; and
providing access, via web browser, to the processed data to users of the IT device.

9. The method of claim 8, wherein the processed data is information about the user's activity on the IT device on the Internet, on a local network, or local activity on the IT device.

10. The method of claim 8, wherein the processed data is information about the user's local activity on the monitored IT device, and not activity associated with the Internet.

11. The method of claim 8, wherein the users of the IT device can browse the processed data, delete certain processed data, indicate certain processed data as private, select persons permitted to access certain processed data, and select persons permitted to access user statistics generated from the processed data.

12. The method of claim 8, wherein processing of the user activity data includes an analyzing of the user activity data by a library of models associated with the control application, the library of models including a plurality of patterns intended for identification of applications by which activities practiced on the IT device can be classified.

13. The method of claim 8, wherein the monitoring application runs in a background of the IT device and monitors and tracks all applications implemented by a user and notes all activity of the user in active time.
